(19) United States
(12) Patent Application Publication
(10) Pub. No.: US 2025/0055022 A1
(43) Pub. Date: Feb. 13, 2025

(54) POLYMER-CERAMIC SOLID ELECTROLYTE

(71) Applicant: UT-Battelle, LLC, Oak Ridge, TN (US)

(72) Inventors: Ritu Sahore, Knoxville, TN (US); Beth L. Armstrong, Oak Ridge, TN (US); Xi Chen, Knoxville, TN (US); Sergiy Kalnaus, Knoxville, TN (US)

(21) Appl. No.: 18/799,454

(22) Filed: Aug. 9, 2024

Related U.S. Application Data
(60) Provisional application No. 63/532,107, filed on Aug. 11, 2023.

(51) Int. Cl. H01M 10/056; H01M 4/02; H01M 4/04

(52) U.S. Cl. CPC H01M 10/056; H01M 4/0471; H01M 2004/021

(57) ABSTRACT

A self-standing, interconnected polymer-ceramic composite solid electrolyte is provided. The composite electrolyte includes a ceramic electrolyte scaffold defining a plurality of interconnected pores having a porosity of 45 to 55%. A crosslinked polymer electrolyte is disposed within the plurality of pores. A surface protection layer, including a linear polymer electrolyte is disposed on an exterior surface of the ceramic electrolyte scaffold. A method of manufacturing a composite electrolyte is also provided. The method includes combining a ceramic electrolyte, a binder, and a solvent to give a ceramic electrolyte slurry cast to give a ceramic electrolyte layer. The ceramic electrolyte layer is sintered to give a porous ceramic electrolyte scaffold defining a porosity of 45 to 55%. A polymer precursor solution is prepared and used to infiltrate the ceramic electrolyte and then cured.

### CROSS-REFERENCE TO RELATED APPLICATIONS

This application claims the benefit of U.S. Provisional Application 63/532,107, filed Aug. 11, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a self-standing, interconnected polymer-ceramic composite solid electrolyte and associated method.

### BACKGROUND OF THE INVENTION

Solid electrolytes are promising in enabling lithium metal to replace conventional graphite anodes and liquid electrolytes, thereby significantly increasing the capacity and energy density of lithium-ion batteries. There are two broad classes of solid electrolytes: inorganic oxide or sulfide-based electrolytes and polymer-based electrolytes. Inorganic electrolytes offer excellent ionic conductivities (e.g., in a range of from 10⁻⁴ to 10⁻² S/cm). Unfortunately, inorganic electrolytes suffer from brittleness and are difficult to process. In contrast, solid polymer electrolytes offer the advantages of flexibility, good adhesion to electrodes, and are relatively inexpensive. Despite their advantages, however, solid polymer electrolytes have suboptimal room-temperature ionic conductivity and insufficient strength to prevent lithium dendrite growth. Composite electrolytes combining inorganic ceramic electrolyte particles with a polymer electrolyte matrix have been considered as a solution, however while showing improved mechanical properties, composite electrolytes do not have efficient ion transport due to large interparticle contact resistance between the ceramic and the polymer.

### SUMMARY OF THE INVENTION

A self-standing, interconnected polymer-ceramic composite solid electrolyte is provided. The composite electrolyte includes a ceramic electrolyte scaffold. The scaffold defines a plurality of interconnected pores. The composite electrolyte also includes a crosslinked polymer electrolyte disposed within the plurality of interconnected pores. The composite electrolyte further includes a surface protection layer disposed on an exterior surface of the ceramic electrolyte scaffold. Generally, the ceramic electrolyte scaffold defines a porosity of 45 to 55%.

A method of manufacturing a composite electrolyte is also provided. The method includes a step of combing a ceramic electrolyte, a binder, and a solvent to give a ceramic electrolyte slurry. The ceramic electrolyte slurry is cast to give a ceramic electrolyte layer. The ceramic electrolyte layer is sintered to give a ceramic electrolyte scaffold defining a plurality of interconnected pores. Generally, the ceramic electrolyte scaffold defines a porosity of 45 to 55%. A polymer precursor solution is prepared. The plurality of interconnected pores are infiltrated with the polymer precursor solution, which is then cured to give a composite electrolyte including crosslinked polymer electrolyte disposed within the plurality of pores.

These and other features of the invention will be more fully understood and appreciated by reference to the description of the embodiments and the drawings.

### BRIEF DESCRIPTION OF THE DRAWING

FIG. 1 is an illustration of a method for manufacturing a self-standing, interconnected polymer-ceramic composite solid electrolyte.

FIG. 2A is a graph depicting the ionic conductivity of a crosslinked polymer electrolyte, a dense ceramic electrolyte, and two inventive composite solid electrolyte as a function of the inverse of temperature.

FIG. 2B is a bar graph depicting the ionic conductivity of ceramic electrolyte scaffold and trilayer composite solid electrolytes.

FIG. 2C is a bar graph depicting the area specific impedance for ceramic electrolyte scaffolds and trilayer composite solid electrolytes, depicting the component of impedance traceable to bulk impedance and interfacial impedance, respectively.

### DETAILED DESCRIPTION OF THE CURRENT EMBODIMENTS

As discussed herein, the current embodiments relate to a self-standing, interconnected polymer-ceramic composite solid electrolyte. The composite electrolyte includes a ceramic electrolyte scaffold. The scaffold defines a plurality of interconnected pores. The composite electrolyte also includes a crosslinked or a linear polymer electrolyte disposed within the plurality of interconnected pores. The composite electrolyte further includes a surface protection layer disposed on an exterior surface of the ceramic electrolyte scaffold. Generally, the ceramic electrolyte scaffold defines a porosity of 45 to 55%.

The composite solid electrolyte includes a ceramic electrolyte scaffold. The ceramic electrolyte scaffold defines a plurality of interconnected pores. The ceramic electrolyte scaffold may therefore be described as a porous ceramic electrolyte scaffold. The ceramic electrolyte scaffold may have a thickness of less than 500 μm, alternatively less than 300 μm, alternatively less than 200 μm, alternatively about 175 μm. The ceramic electrolyte scaffold may define a porosity of 30 to 80%, alternatively 45 to 55%, alternatively 47 to 53%, alternatively 49 to 51%, alternatively 49.5 to 50.5%, alternatively 43 to 53%, alternatively 45 to 51%, alternatively 46 to 48%, alternatively 47 to 49%, alternatively 47.5 to 48.5%. Porosity % is defined as the volume percent of the ceramic electrolyte scaffold that is not filled by the ceramic electrolyte and may be alternatively described as the void fraction of the ceramic electrolyte scaffold. The ceramic electrolyte scaffold defines a tortuosity of less than 100, alternatively less than 20, alternatively less than 15, alternatively less than 12, alternatively less than 10, alternatively less than 8, alternatively less than 7, alternatively less than 6, alternatively less than 5, alternatively less than 4, alternatively less than 3, alternatively between 2 and 5, alternatively 1.9 to 3.5, alternatively less than 2, alternatively between 1 and 1.9, alternatively between 1 and 1.8, alternatively 1.2 to 1.8, alternatively between 1.5 and 1.8. The lower the tortuosity, the greater the ionic conductivity. Tortuosity is calculated using the following formula.

$$Tortuosity = \frac{Total Path Length}{Straight Line Distance}$$

In some embodiments, the ceramic electrolyte scaffold comprises, alternatively consists essentially of, alternatively consists of a lithium-ion conducting glass-ceramic or ceramic. The lithium-ion conducting glass ceramic may conform to the formula Li_{1+x+y}AlₓTi₂₋ₓSi_{y}P_{3-y}O₁₂, wherein x is 0, 1, or 2 and y is 0, 1, 2, or 3. Examples of suitable lithium-ion conducting glass/ceramics include Li₇La₃Zr₂O₁₂ (LLZO), Li_{6.4}La₃Zr_{1.4}Ta_{0.6}O₁₂ (LLZTO), Li₁₊ₓAlₓTi₂₋ₓ(PO₄)₃ (LATP), Li_{1.3}Al_{0.3}Ti_{1.7}(PO₄)₃ (LATP), LiLaTiO₃ (LLTO), Li₂S—P₂S₅, Li₃PS₄ (LPS), Li₆PS₅Cl (LPSCl), Li₃PO₄, Li₂O·2P₂O₅, Li₂SiO₃, Li₂SiO₄, Li₂B₄O₇, Li₂S—P₂S₅—Cu₂S, Li₂S—P₂S₅—B₂S₃, Li₁₀GeP₂S₁₂ (LGPS), or combinations thereof.

The ceramic electrolyte scaffold may formed by sintering a ceramic electrolyte layer comprising a ceramic and a binder. The ceramic and the binder may be present in the ceramic electrolyte layer in a weight ratio of 90:10 to 99.99:0.01, alternatively 95:5 to 99.99:0.01; alternatively 97:3 to 99.9:0.1; alternatively 98:2 to 99.5:0.5; alternatively 98.5:1.5 to 99:1; alternatively 98.75:1.25 to 99.25:0.75.

The composite electrolyte includes a crosslinked or linear polymer electrolyte disposed within the plurality of pores of the ceramic electrolyte scaffold. The inclusion of the crosslinked polymer electrolyte increases the mechanical flexibility and toughness of the composite electrolyte, while also improving processability. The crosslinked polymer electrolyte may include a dual-ion conducting polymer electrolyte (DICPE) and/or single-ion conducting polymer electrolyte (SICPE). The DICPE includes a lithium salt and a polymer matrix. The lithium salt may be lithium bis(trifluoromethhanesulfonyl)imide, lithium trifluoromethanesulfonate, lithium perchlorate, lithium tetrafluoroborate, or combinations thereof. The polymer matrix may be poly(ethylene oxide), poly(vinylidene difluoride-cohexafluoropropylene), poly(methyl methacrylate), poly(propylene carbonate), poly(acrylonitrile), or combinations thereof. The SICPE may be lithium poly(4-styrenesulfonyl(trifluoromethylsulfonyl)imide), lithium poly[(4-styrenesulfonyl)(trifluoromethyl(S-trifluoromethylsulfonylimino)sulfonyl)imide], lithium poly(tetrafluorostyrene sulfonate)-polyether, or combinations thereof.

The composite electrolyte includes a surface protection layer disposed on an exterior surface of the ceramic electrolyte scaffold. In some embodiments, the ceramic electrolyte scaffold defines a pair of faces on opposite sides of the ceramic electrolyte scaffold. In these embodiments, the composite electrolyte may include a pair of surface protection layers, with one surface protection layer defined on each face of the ceramic electrolyte scaffold. The surface protection layer includes a linear or crosslinked polymer electrolyte. The surface polymer electrolyte may be the same or different than the crosslinked polymer electrolyte. The surface polymer electrolyte may include the DICPE and/or the SICPE. The surface protection layer may have a thickness of less than 20 μm, alternatively less than 10 μm, alternatively less than 5 μm.

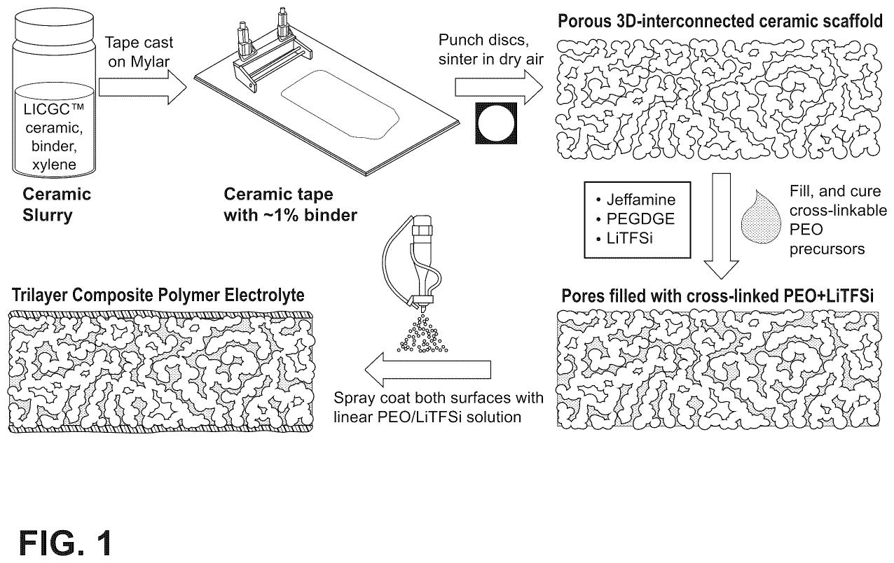

A method of manufacturing a composite electrolyte is also provided. The method is generally depicted schematically in FIG. 1. The method includes combining a ceramic electrolyte, a binder, and a solvent to form a ceramic electrolyte slurry. The ceramic electrolyte slurry is cast to give a ceramic electrolyte layer. The ceramic electrolyte layer is sintered to form a ceramic electrolyte scaffold defining a plurality of interconnected pores. The ceramic electrolyte scaffold defines a porosity of 45 to 55%. A polymer precursor solution is prepared. The plurality of interconnected pores are infiltrated with the polymer precursor solution. The polymer precursor solution is cured to form a composite electrolyte including crosslinked polymer electrolyte disposed within the plurality of pores.

The method includes the step of combining a ceramic electrolyte, a binder, and a solvent to form a ceramic electrolyte slurry. The ceramic electrolyte may be a ceramic powder, and the ceramic powder may include a lithium-ion conducting glass/ceramic. The binder may comprise a branched hydrocarbon polymer (e.g., MSB1-13 from Polymer Innovations, Inc.). The solvent may comprise xylene. The ceramic electrolyte slurry may be formed using a jack/ball mill method. The method further includes the step of casting the ceramic electrolyte slurry to form a ceramic electrolyte layer. The ceramic electrolyte slurry is generally cast to give a ceramic electrolyte layer using a tape caster (e.g., using a Mistler tape caster). The ceramic electrolyte layer may have a thickness of less than 500 μm, alternatively less than 300 μm, alternatively less than 200 μm, alternatively about 175 μm.

The ceramic electrolyte layer is sintered to form a ceramic electrolyte scaffold defining a plurality of interconnected pores. The step of sintering the ceramic electrolyte layer may be performed at a sintering temperature of from 400 to 1700° C., alternatively 600 to 1400° C., alternatively 800 to 1200° C., for a sintering time of 1 to 5 hours, alternatively 2 to 4 hours, alternatively about 3 hours. In some embodiments, the ceramic electrolyte layer is sintered in multiple stages at independently selected sintering temperatures for independently selected sintering times. In certain embodiments, the ceramic electrolyte layer is sintered in a first stage and a second stage. The ceramic electrolyte layer is sintered at a first sintering temperature of from 300 to 900° C., alternatively 400 to 800° C., alternatively 500 to 700° C., alternatively about 600° C. for a first sintering time of 1 to 3 hours, alternatively about 2 hours. The ceramic electrolyte layer is then sintered at a second sintering temperature of from 800 to 1200° C., alternatively 900 to 1100° C., or about 1000° C. for a second sintering time of 1 to 15 hours, alternatively 2 to 4 hours, alternatively about 3 hours, alternatively 5 to 7 hours, alternatively about 6 hours, alternatively 8 to 10 hours, alternatively about 9 hours. In specific embodiments, the ceramic electrolyte layer is sintered in the first stage, the second stage, and a subsequent third stage at a third sintering temperature of from 1000° C. to 1100° C., alternatively about 1050° C. for a third sintering time of 0.25 to 3 hours, alternatively about 0.5 hours, alternatively about 1 hour, alternatively about 1.5 hours.

The ceramic electrolyte scaffold may define a porosity of 30 to 80%, alternatively 45 to 55%, alternatively 47 to 53%, alternatively 49 to 51%, alternatively 49.5 to 50.5%, alternatively 43 to 53%, alternatively 45 to 51%, alternatively 46 to 48%, alternatively 47 to 49%, alternatively 47.5 to 48.5%. The porosity of the ceramic electrolyte scaffold will be determined by the sintering temperature and the sintering time. The greater the sintering temperature and the longer the sintering time, the lower the porosity of the ceramic electrolyte scaffold.

The method also includes the step of preparing a polymer precursor solution. Generally, the step of preparing a polymer precursor solution comprises combining (A) a polymer; (B) a crosslinker; and (C) a lithium electrolyte salt. In embodiments where the composite electrolyte comprises a DICPE, the (A) polymer may include an amino-functional polyethylene oxide; the (B) crosslinker may include an epoxy-functional polyethene oxide; and the (C) lithium salt may include lithium bis(trifluoromethhanesulfonyl)imide. In embodiments where the composite electrolyte comprises a SICPE, the (A) polymer may include an acrylate-functional polyethylene oxide; the (B) crosslinker may include vinyl ethylene carbonate; and the (C) lithium salt may include lithium sulfonyl(trifluoromethane sulfonyl)imide styrene. In these embodiments, the polymer precursor solution may further comprise (D) a radical initiator. In certain embodiments, the radical initiator includes asobisisobutyronitrile. Once prepared, the polymer precursor solution is used to infiltrate the plurality of interconnected pores of the ceramic electrolyte scaffold.

In embodiments where the polymer precursor solution is used to form a linear polymer electrolyte the step of preparing a polymer solution comprises combining (A) polymer precursors; (B) a lithium electrolyte salt; and (E) a solvent. In specific embodiments, the (A) polymer comprises acrylate-functional poly(ethylene oxide); the (B) lithium salt comprises lithium bis(trifluoromethhanesulfonyl)imide; the (E) solvent comprises tetraethylene glycol dimethyl ether; and the polymer precursor solution further comprises (D) a radical initiator comprising azobisisobutyronitrile. In some embodiments, the (A) polymer precursors comprise vinyl ethylene carbonate; the (B) lithium salt comprises lithium bis(trifluoromethhanesulfonyl)imide; and the polymer precursor solution further comprises (D) a radical initiator comprising azobisisobutyronitrile.

The method further includes the step of curing the polymer precursor solution to give a composite electrolyte comprising crosslinked polymer electrolyte disposed within the plurality of pores. Generally, the step of curing the polymer precursor solution to give a composite electrolyte further includes heating the polymer precursor solution to a curing temperature of 60 to 140° C., alternatively 80 to 120° C., alternatively 90 to 110° C., alternatively about 100° C. for a curing time of 2 to 6 hours, alternatively 3 to 5 hours, alternatively about 4 hours. The method may further include the step of drying the composite electrode at a drying temperature of 30 to 90° C., alternatively 50 to 70° C. for a drying time of 1 to 5 days, alternatively 2 to 4 days.

In some embodiments, the method further comprises the step of coating two sides of the composite electrolyte with a layer of linear polymer electrolyte. Generally, the two sides of the composite electrolyte are spay coated with the layer of linear polymer electrolyte. The linear polymer electrolyte may be the same as or different than the crosslinked polymer electrolyte. The linear polymer electrolyte may include the DICPE and/or the SICPE. The surface protection layer may have a thickness of less than 20 μm, alternatively less than 10 μm, alternatively less than 5 μm.

### EXAMPLES

The present method is further described in connection with the following examples, which are non-limiting.

### General Procedure

A plurality of lithium-ion conducting glass ceramic (LICGC) particles having a diameter of 1 μm were provided. The LICGC particles, an MSB1-13 binder, and xylene solvent were combined to give an LICGC slurry. A low solids slurry was prepared including 38.9 wt. % LICGC, 0.5 wt. % binder, and 60.6 wt. % xylene. The low solids slurry has a ceramic/binder ratio of 98.7:1.3 (no solvent). The high solids slurry was prepared including 49.6 wt. % LICGC, 0.5 wt. % binder, and 49.9 wt. % xylene. The high solids slurry has a ceramic/binder ratio of 99:1 (no solvent). The LICGC slurry was cast on a tape caster (Mistler) to give a uniform LICGC layer of ˜175 μm. The LICGC layer was sintered to obtain a porous ceramic electrolyte scaffold. After sintering, the ceramic electrolyte scaffold was filled with a Crosslinked Polymer Electrolyte. A thin (<5 μm) uniform layer of linear Polymer Electrolyte coating was applied on two surfaces of the ceramic electrolyte scaffold.

### DICPE Preparation Method

A polymer electrolyte precursor solution was prepared by combining 0.64 g of Jeffamine ED2003 (Eastman), 0.35 g of LiTFSI (3M), and 0.60 g of ethanol (Sigma-Aldrich) in a glass vial. The polymer electrolyte precursor solution was stirred at room temperature for about 30 minutes until a clear solution was obtained. The polymer electrolyte precursor solution was then placed in a vacuum oven at room temperature overnight to evaporate off the ethanol. An amount of 0.32 PEDGE 500 (Mn 500, Sigma-Aldrich) was added to the polymer electrolyte precursor solution and stirred for about 1 hour to obtain a viscous precursor solution. An amount of precursor needed to achieve 100% infiltration of the ceramic electrolyte scaffold was calculated based on the porosity % of the ceramic electrolyte scaffold and density of the cross-linked PEO+LiTFSI polymer (1.4 g/cm³). Approximately 5-10% less than the calculated amount was dropped into the ceramic electrolyte scaffold to ensure no excess surface polymer layer was present.

The infiltrated ceramic electrolyte scaffold was left covered overnight at room temperature to allow the viscous precursor solution to completely infiltrate the ceramic electrolyte. The infiltrated ceramic electrolyte was transferred to an oven at 100° C. to thermally cure the viscous precursor solution. After four hours of curing, a vacuum was applied to the composite electrolyte and the composite electrolyte was dried for 50 to 60° C. for several days. After drying the composite electrolyte was transferred to a spray coater for depositing thin layers of linear PEO+LiTFSI polymer electrolyte on the two surfaces of the composite electrolyte. The linear PEO+LiTFSI includes acetonitrile, PEO (MW 400,000, Sigma-Aldrich), and LiTFSI, where the concentration of PEO was 0.5 wt. % and the weight ratio of PEO to LiTFSI was 3:1.

### SICPE Preparation Method

A polymer electrolyte precursor solution was prepared by combining 1.16 g of vinyl ethylene carbonate (VEC), 0.29 g of lithium sulfonyl(trifluoromethane sulfonyl)imide styrene (LiSTFSI), 0.50 g of polyethylene glycol dimethacrylate (Mn 1000, Sigma-Aldrich), and 0.01 g of azobisisobutyronitrile (AIBN). An amount of precursor needed to achieve 100% infiltration of the ceramic electrolyte scaffold was calculated based on the porosity % of the ceramic electrolyte scaffold and density of the cross-linked polymer electrolyte precursor solution. A 50% excess of the calculated amount was dropped into the ceramic electrolyte scaffold to allow excess polymer precursor solution to accumulate at the top and bottom surfaces of the composite electrolyte.

The infiltrated ceramic electrolyte scaffold was left covered overnight at room temperature to allow the viscous precursor solution to completely infiltrate the ceramic electrolyte. The infiltrated ceramic electrolyte was transferred to an oven at 80° C. to thermally cure the viscous precursor solution. After four hours of curing, a vacuum was applied to the composite electrolyte and the composite electrolyte was dried for 50 to 60° C. for several days.

### Examples 1-9 and Comparative Examples 1-2

Examples 1-9 and Comparative Examples 1-2 were prepared according to the General Procedure and DICPE Preparation Method. Details of the deviations of Examples 1-9 and Comparative Examples 1-2 from the General Procedure are provided in Table 1 presented below.

TABLE 1

| | | | Porosity | |
|---|---|---|---|---|
| | | | Volume | Ionic |
| | Electrolyte | | Fraction | Conductivity |
| | Scaffold | Sintering Details | (%) | (S/cm) |
| Ex. 1 | Low Solids | 600° C. for 2 hours, then | 52% | 2.6 × 10⁻⁶ |
| | | 1000° C. for 3 hours | | |
| Ex. 2 | Low Solids | 600° C. for 2 hours, then | 49% | 7.9 × 10⁻⁶ |
| | | 1000° C. for 6 hours | | |
| Ex. 3 | Low Solids | 600° C. for 2 hours, then | 51% | 4.1 × 10⁻⁶ |
| | | 1000° C. for 9 hours | | |
| Ex. 4 | Low Solids | 600° C. for 2 hours, then | 9% | 4.8 × 10⁻⁵ |
| | | 1100° C. for 3 hours | | |
| Ex. 5 | Low Solids | 600° C. for 2 hours, then | 40% | 3.5 × 10⁻⁵ |
| | | 1000° C. for 3 hours, then | | |
| | | 1050° C. for 1.5 hours | | |
| Ex. 6 | Low Solids | 600° C. for 2 hours, then | 46% | 1.9 × 10⁻⁵ |
| | | 1000° C. for 3 hours, then | | |
| | | 1050° C. for 1.0 hours | | |
| Ex. 7 | Low Solids | 600° C. for 2 hours, then | 46% | 1.7 × 10⁻⁵ |
| | | 1000° C. for 3 hours, then | | |
| | | 1050° C. for 0.5 hours | | |
| Ex. 8 | High Solids | 600° C. for 2 hours, then | 48% | 1.2 × 10⁻⁵ |
| | | 1000° C. for 3 hours | | |
| Ex. 9 | Low Solids | Step-wise burn at 200° C., | 52% | 2.3 × 10⁻⁶ |
| | | 350° C., 450° C., 500° C., | | |
| | | and 600° C., each step for | | |
| | | 1 hour, and 1000° C. for 3 | | |
| | | hours | | |
| CE 1 | Dense | No sintering | ~0% | 2.9 × 10⁻⁴ |
| | LICGC | | | |
| | Plate | | | |
| CE 2 | Hydraulic | Step-wise burn at 200° C., | 45% | 1.8 × 10⁻⁵ |
| | Pressed | 350° C., 450° C., 500° C., | | |
| | Low Solids | and 600° C., each step for | | |
| | Pellet | 1 hour, and 1000° C. for 3 | | |
| | | hours | | |

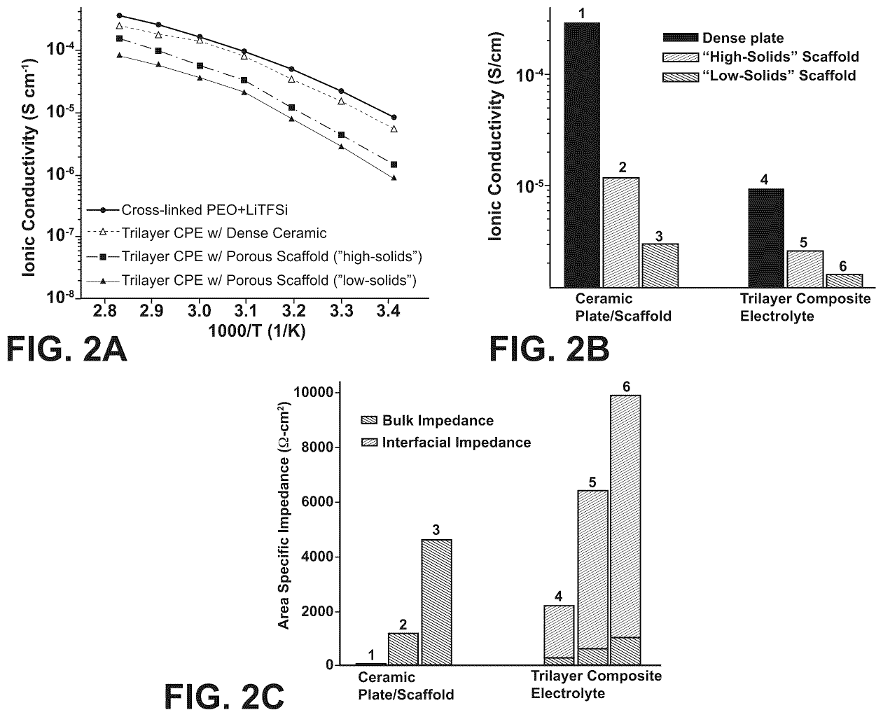

FIG. 2A is an Arrhenius plot depicting the ionic conductivity of several substrates relative to the inverse of temperature. Specifically, the substrates depicted include the control cross-linked PEO+LiTFSI and the control trilayer CPE with dense ceramic, along with the inventive trilayer CPE with the high solids porous scaffold and trilayer CPE with the low solids porous scaffold. As shown in FIG. 2A, the pure cross-linked PEO+LiTFSI has the highest ionic conductivity, while the trilayer CPE with dense ceramic has the second highest ionic conductivity. The inventive trilayer CPEs both demonstrate lower ionic conductivity than the control cross-linked PEO+LiTFSI and trilayer CPE with dense ceramic. The trilayer CPE with the porous high-solids scaffold demonstrates higher ionic conductivity than the trilayer CPE with the porous low-solids scaffold.

FIG. 2B is a bar graph depicting the ionic conductivity of bare dense plate ceramic scaffold, a bare high-solids ceramic scaffold, and a bare low-solids ceramic scaffold. The ionic conductivities of the trilayer composite electrolytes including the dense plate ceramic scaffold, the high-solids ceramic scaffold, and the low-solids ceramic scaffold are also depicted. The bare ceramic electrolyte scaffolds all demonstrate higher ionic conductivities than the respective trilayer composite electrolytes. For both the bare ceramic scaffolds and the trilayer composite electrolytes the dense plate ceramic has a higher ionic conductivity than the high-solids ceramic electrolyte which in turn has a higher ionic conductivity than the low-solids ceramic electrolyte.

FIG. 2C is a bar graph depicting the area specific impedance of bare dense plate ceramic scaffold, a bare high-solids ceramic scaffold, and a bare low-solids ceramic scaffold. The area specific impedance of the trilayer composite electrolytes including the dense plate ceramic scaffold, the high-solids ceramic scaffold, and the low-solids ceramic scaffold is also depicted. The total impedance of the bare scaffolds is less than the total impedance of the respective trilayer composite electrolytes. For both the bare ceramic scaffolds and the trilayer composite electrolytes the dense plate ceramic has a lower impedance than the high-solids ceramic electrolyte which in turn has a lower impedance than the low-solids ceramic electrolyte. A majority of the total impedance of the trilayer composite electrolytes is contributed by the interfacial impedance between the ceramic electrolyte and the polymer electrolyte.

Notably, at higher currents, the polymer electrolyte and the inventive high-solids trilayer CPE presented steep overpotentials. The control trilayer CPE with dense ceramic had the flattest overpotentials at 0.2 mA/cm² and was able to maintain flat potentials at higher currents, but experienced substantial and undesirable dendrite growth, which was largely avoided by the high-solids trilayer CPE due to the inclusion of the specific volume % of polymer electrolyte. Relatedly, DICPEs tend to have relatively low Li-ion transference (<0.5), while SICPEs generally have higher transference (close to 1). Generally, the composite electrolyte demonstrates excellent lithium-ion transference.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. As used herein, the term “about” indicates values within the range of ±25%, alternatively ±10%, alternatively ±5%, alternatively ±1% of the modified value.

1. A self-standing, interconnected polymer-ceramic composite solid electrolyte, the composite electrolyte comprising:
a ceramic electrolyte scaffold defining a plurality of interconnected pores;
a crosslinked polymer electrolyte disposed within the plurality of pores; and
a surface protection layer disposed on an exterior surface of the ceramic electrolyte scaffold; and
wherein the surface protection layer comprises a linear polymer electrolyte; and
wherein the ceramic electrolyte scaffold defines a porosity of 45 to 55%.

2. The composite electrolyte of claim 1, wherein the ceramic electrolyte scaffold defines a porosity of 46 to 48%.

3. The composite electrolyte of claim 1, wherein the ceramic electrolyte scaffold defines a tortuosity of less than 10.

4. The composite electrolyte of claim 3, wherein the ceramic electrolyte scaffold defines a tortuosity of less than 5.

5. The composite electrolyte of claim 1, wherein the ceramic electrolyte scaffold is a ceramic electrolyte scaffold formed by sintering a ceramic electrolyte layer comprising a ceramic and a binder in a weight ratio of 98.75:1.25 to 99.25:0.75.

6. The composite electrolyte of claim 1, wherein the ceramic electrolyte scaffold comprises a lithium-ion conducting glass-ceramic or ceramic.

7. The composite electrolyte of claim 1, wherein the crosslinked polymer electrolyte and/or the linear polymer electrolyte comprises a dual-ion conducting polymer electrolyte comprising:
a lithium salt selected from the group consisting of lithium bis(trifluoromethhanesulfonyl)imide, lithium trifluoromethanesulfonate, lithium perchlorate, lithium tetrafluoroborate, and combinations thereof; and
a polymer matrix selected from the group consisting of poly(ethylene oxide), poly(vinylidene difluoride-cohexafluoropropylene), poly(methyl methacrylate), poly(propylene carbonate), poly(acrylonitrile), and combinations thereof.

8. The composite electrolyte of claim 1, wherein the crosslinked polymer electrolyte and/or the linear polymer electrolyte comprises a single-ion conducting polymer electrolyte selected from the group consisting of lithium poly(4-styrenesulfonyl(trifluoromethylsulfonyl)imide), lithium poly[(4-styrenesulfonyl)(trifluoromethyl(S-trifluoromethylsulfonylimino)sulfonyl)imide], lithium poly(tetrafluorostyrene sulfonate)-polyether, and combinations thereof.

9. A self-standing, interconnected polymer-ceramic composite solid electrolyte, the composite electrolyte comprising:
a ceramic electrolyte scaffold defining a plurality of interconnected pores;
a linear polymer electrolyte disposed within the plurality of pores; and
a surface protection layer disposed on an exterior surface of the ceramic electrolyte scaffold; and
wherein the surface protection layer comprises the linear polymer electrolyte; and
wherein the ceramic electrolyte scaffold defines a porosity of 45 to 55%.

10. The composite electrolyte of claim 9, wherein the ceramic electrolyte scaffold defines a porosity of 46 to 48%.

11. The composite electrolyte of claim 9, wherein the ceramic electrolyte scaffold defines a tortuosity of less than 10.

12. The composite electrolyte of claim 11, wherein the ceramic electrolyte scaffold defines a tortuosity of less than 5.

13. The composite electrolyte of claim 9, wherein the ceramic electrolyte scaffold is a ceramic electrolyte scaffold formed by sintering a ceramic electrolyte layer comprising a ceramic and a binder in a weight ratio of 98.75:1.25 to 99.25:0.75.

14. The composite electrolyte of claim 9, wherein the ceramic electrolyte scaffold comprises a lithium-ion conducting glass-ceramic or ceramic.

15. The composite electrolyte of claim 9, wherein the linear polymer electrolyte comprises a dual-ion conducting polymer electrolyte comprising:
a lithium salt selected from the group consisting of lithium bis(trifluoromethhanesulfonyl)imide, lithium trifluoromethanesulfonate, lithium perchlorate, lithium tetrafluoroborate, and combinations thereof; and
a polymer matrix selected from the group consisting of poly(ethylene oxide), poly(vinylidene difluoride-cohexafluoropropylene), poly(methyl methacrylate), poly(propylene carbonate), poly(acrylonitrile), and combinations thereof.

16. The composite electrolyte of claim 9, wherein the linear polymer electrolyte comprises a single-ion conducting polymer electrolyte selected from the group consisting of lithium poly(4-styrenesulfonyl(trifluoromethylsulfonyl)imide), lithium poly[(4-styrenesulfonyl)(trifluoromethyl(S-trifluoromethylsulfonylimino)sulfonyl)imide], lithium poly(tetrafluorostyrene sulfonate)-polyether, and combinations thereof.

17. A method of manufacturing a composite electrolyte, the method comprising the steps of:
combining a ceramic electrolyte, a binder, and a solvent to give a ceramic electrolyte slurry;
casting the ceramic electrolyte slurry to give a ceramic electrolyte layer;
sintering the ceramic electrolyte layer to give a ceramic electrolyte scaffold defining a plurality of interconnected pores;
preparing a polymer precursor solution;
infiltrating the plurality of interconnected pores with the polymer precursor solution; and
curing the polymer precursor solution to give a composite electrolyte comprising crosslinked polymer electrolyte disposed within the plurality of pores; and
wherein the ceramic electrolyte scaffold defines a porosity of 45 to 55%.

18. The method of claim 17, wherein the method further comprises the step of coating two sides of the composite electrolyte with a layer of linear or crosslinked polymer electrolyte.

19. The method of claim 17, wherein the step of sintering the ceramic electrolyte layer is performed at a sintering temperature of from 600 to 1400° C. for a sintering time of 1 to 5 hours.

20. The method of claim 17, wherein the step of curing the polymer precursor solution to give a composite electrolyte further comprises heating the polymer precursor solution to a curing temperature of 60 to 140° C. for a curing time of 2 to 6 hours.
